(19) United States
(12) Patent Application Publication
(10) Pub. No.: US 2009/0223622 A1
(43) Pub. Date: Sep. 10, 2009

(54) Self adhering fabric patch

(75) Inventor: Mark Llano, Wellington, FL (US)

Correspondence Address: ROBERT M. DOWNEY, P.A., 6751 N. FEDERAL HWY., SUITE 300, BOCA RATON, FL, 33487, US

(73) Assignees: Mark Llano 51%; Randall Webb 49%

(21) Appl. No.: 12/228,617

(22) Filed: Aug. 14, 2008

Related U.S. Application Data
(62) Division of application No. 12/074,623, filed on Mar. 4, 2008.

(51) Int. Cl. B32B 37/12; B32B 27/04

(52) U.S. Cl. 156/94; 442/151; 428/41.7; 428/195.1

(57) ABSTRACT

A patch for repairing a tear or hole in clothing or gear includes a fabric and a pressure sensitive adhesive bonded to the fabric by hot melt lamination. A release paper covers the pressure sensitive adhesive and is removed to allow application of the patch to the clothing or other item being repaired. The patch is attached by applying pressure to the top fabric surface of the patch for approximately 45 seconds using the convex surface of a spoon-like object.

### BACKGROUND OF THE INVENTION

This application is a divisional patent application of co-pending U.S. patent application Ser. No. 12/074,623 filed on Mar. 4, 2008.

1. Field of the Invention

The present invention is directed to a self-adhering fabric patch for repairing clothing, and more particularly, to a self-adhering patch for quickly repairing tears or openings in clothing and gear without the use of a hot iron or a thread and needle.

2. Discussion of the Related Art

The fabric of outdoor garments and gear is susceptible to excessive wear and tearing during use. In particular, items of clothing and gear used for hunting, hiking, climbing, skiing and other outdoor sports activities are exposed to rugged environments that can result in worn openings and/or tears in the clothing or gear fabric. The torn fabric must then be repaired in order to preserve the garment or gear. Ordinarily, repairing the fabric is accomplished by stitching the tear closed with a needle and thread, preferably with the use of a sewing machine. Alternatively, the worn opening or tear can be repaired with a patch that attaches to the clothing fabric and covers the damaged area. In most instances, a worn opening in fabric cannot be stitched closed and can only be repaired with the use of a patch. It is preferable that the patch match the color and pattern of the clothing or gear fabric to reduce visibility of the patch when attached to the damaged fabric.

Presently, the attachment of a repair patch to a garment or other fabric article is accomplished by either stitching with a needle and thread or by hot melt adhesion using an electric iron. Stitching the patch to the fabric is labor intensive and is best accomplished with the use of an electric sewing machine. Due to the need for special skills and electric equipment, neither the stitching method nor the hot melt adhesion method is suited for field repairs. Instead, the torn garment or gear must be taken to a tailor, seamstress or other skilled professional for repair after completion of the outdoor activity. The inability to repair the damaged garment or gear, during the activity (i.e., in the field) is inconvenient, potentially costly, and may result in further damage to the garment or gear as well as possible injury to the user while performing the outdoor activity with the damaged clothing or gear.

Accordingly, there remains a definite need for a repair patch that can be quickly and easily attached to a garment or other fabric article to repair tears and openings in the fabric of the garment or other article without the need for special equipment, electric power or unique skills.

### OBJECTS AND ADVANTAGES OF THE INVENTION

Considering the foregoing, it is a primary object of the present invention to provide a patch for repairing tears and openings in garments without the use of stitching, and wherein the repair patch includes a pressure sensitive adhesive that allows the patch to be fully bonded to the garment in approximately 45 seconds.

It is a further object of the present invention to provide a repair patch that includes a fabric layer that matches the garment being repaired, and further wherein the patch includes a pressure sensitive adhesive laminated to a bottom side of the fabric to enable easy application and attachment of the patch to a garment in order to fully cover a tear or opening in the garment.

It is still a further object of the present invention to provide a repair patch that is particularly suited for repairing tears and holes in clothing and fabric equipment or equipment covers, and wherein the patch includes a fabric with a digitally printed pattern that matches the pattern of the clothing, equipment, or equipment covers.

It is still a further object of the present invention to provide a patch that quickly and easily attaches to a garment or other fabric article by applying pressure, such as with the use of a spoon-like object, in approximately 45 seconds and without the use of a needle and thread.

It is yet a further object of the present invention to provide a fabric patch for repairing tears and openings in garments, such as outdoor sports and hunting clothing and gear, and wherein the repair patch attaches by pressure sensitive adhesive and withstands at least 10 complete laundering cycles (i.e. washing and drying) with a maximum separation around the edges of the patch of ⅛ of an inch.

These and other objects and advantages of the present invention are readily apparent with reference to the detailed description and drawings.

### SUMMARY OF THE INVENTION

The present invention is directed to a patch for repairing a tear or hole in clothing and gear. The patch includes a fabric made from aromatic polyamide or other fibers, and a pressure sensitive adhesive bonded to the fabric by hot melt lamination. A release paper covers the pressure sensitive adhesive and is removed to allow application of the patch to the clothing item being repaired. The patch is attached to clothing and gear by applying pressure to the top fabric surface of the patch, pressing firmly to smooth out wrinkles, creases and air pockets, and then rubbing with consistent pressure for approximately 45 seconds, using the convex surface of a spoon-like object, to push the adhesive into the pores of the fabric of the clothing or gear while generating heat to accelerate the adhesion process. The fabric of the patch may be printed with a pattern that matches the color and pattern of the clothing or gear fabric.

### BRIEF DESCRIPTION OF THE DRAWINGS

For a fuller understanding of the nature of the present invention, reference should be made to the following detailed description taken in conjunction with the accompanying drawings in which:

FIG. 1 is an isolated view of a sleeve of a jacket, shown with a tear in the material of the jacket.

FIG. 2 is an isolated perspective view demonstrating the manner of repairing the tear shown in FIG. 1, by first closing the tear using the fingers;

FIG. 3 is a perspective view showing the repair patch of the present invention, and particularly a protective backing paper being peeled away from a pressure sensitive adhesive layer of the patch;

FIG. 4 is an isolated perspective view showing application of the repair patch to the sleeve of the jacket by placing the pressure sensitive adhesive side of the patch over the area surrounding the tear and using the concave side of a spoon-like object to apply pressure to the outer surface of the patch, thereby causing the patch to adhere to the surface of the fabric sleeve of the jacket while closing and covering the tear; and

FIG. 5 is an exploded perspective view showing the structural layers of the repair patch of the present invention.

Like reference numerals refer to like parts throughout the several views of the drawings.

### DETAILED DESCRIPTION OF THE PREFERRED EMBODIMENT

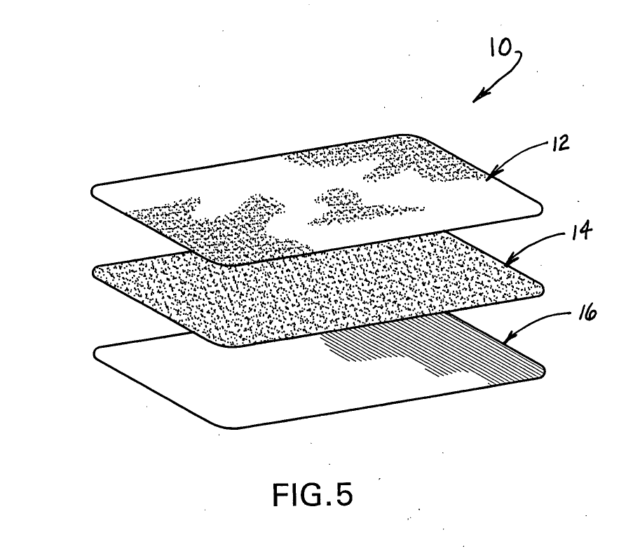

Referring initially to FIG. 5, a preferred embodiment of the repair patch of the present invention is shown and is generally indicated as 10. The repair patch includes a fabric layer 12, a pressure sensitive adhesive 14 that is laminated to the bottom side of the fabric layer 12 by hot melt lamination, and a paper release liner 16 (i.e., backing) for protectively covering the pressure sensitive adhesive prior to application. Examples of material of the fabric layer 12 include, but are not limited to, nylon taslon, polyester tactel, and filament brushed tricot with performance lamination and water resistant poly woven. The patch 10 is die cut to the desired size and is preferably provided with radiused corners. It is contemplated that the patch will be provided in a range of sizes and is generally square or rectangular in shape, although other shapes (e.g., round) are contemplated as well. The patch is packaged, preferably in different sizes (e.g., a total of 8 patches) in a clear plastic bag/envelope with application instructions.

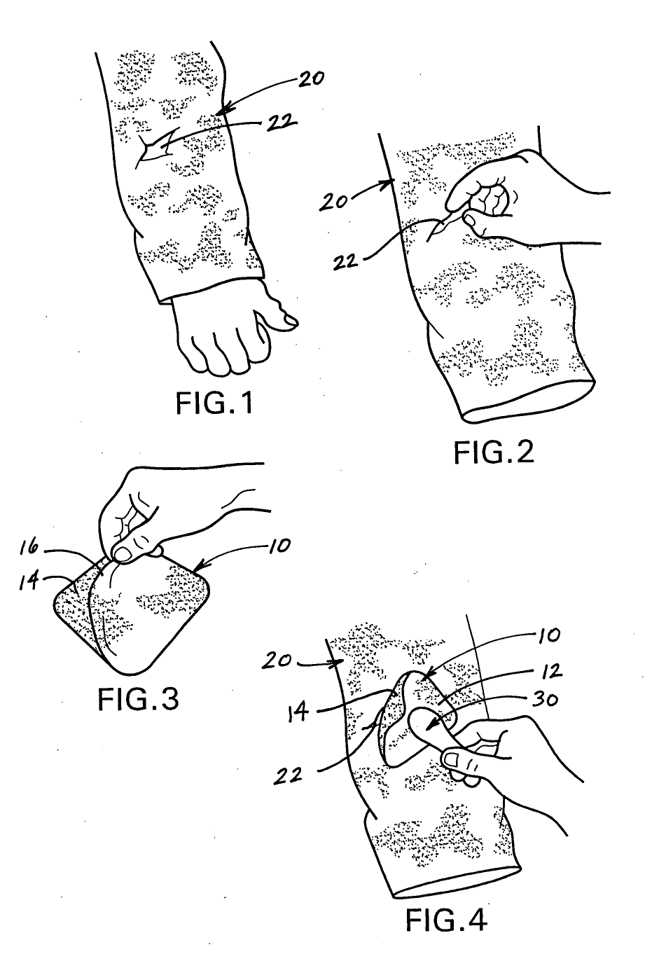

FIGS. 1-4 demonstrate the manner of attachment of the patch 10 to a hunting jacket 20 having a tear 22 in the sleeve. As seen in FIG. 1, the tear creates a significant opening in the sleeve of the jacket 20 that exposes the wearer to the weather elements, as well as exposing the jacket to further damage. FIG. 2 demonstrates the manner of repairing the tear by first lying the garment on a flat, rigid surface and bringing the torn edges of the fabric together, to thereby close the opening in the sleeve. Any excess frayed materials along the torn edges should be trimmed away. The area of application should be free of dirt, sand, oil and other debris. It is preferable that the garment be laundered first, before patch application. Next, in FIG. 3, the patch 10 is prepared for attachment by first removing the peel-away backing paper to expose the pressure sensitive adhesive. Thereafter, as seen in FIG. 4, the patch 10 is placed over the tear, while maintaining the torn edges pulled together, and with the pressure sensitive adhesive applied directly to the outer surface of the jacket material surrounding the tear. Once positioned over the tear, the patch is pressed firmly with the fingers to smooth out wrinkles, creases or air pockets to ensure full adhesion. A spoon-like object 30 is then rubbed on the outer fabric surface of the patch in a reciprocating motion across the entire surface of the patch while applying pressure. The reciprocating motion and pressure exerted by the concave surface of the spoon-like object 30 against the patch pushes the adhesive into the fabric of the garment and generates heat and pressure to cause the pressure sensitive adhesive to fully bond with the exterior fabric of the garment. After approximately 45 seconds of rubbing with consistent pressure, the patch will be fully adhered to the garment, thereby covering and maintaining the tear closed.

While the present invention has been shown and described in accordance with a preferred and practical embodiment thereof, it is recognized that departures from the instant disclosure are contemplated within the spirit and scope of the present invention, which is not to be limited except as defined in the following claims as interpreted under the Doctrine of Equivalents.

What is claimed is:

1. A patch for repairing a tear or hole in an article of clothing, comprising:
a sheet of fabric having a top side and a bottom side; and
a pressure sensitive adhesive composition bonded to the bottom side of said fabric sheet by heat melt lamination.

2. The patch as recited in claim 1 further comprising:
a removable backing sheet for protectively covering said pressure sensitive adhesive prior to application of said patch to the article of clothing.

3. The patch as recited in claim 1 wherein the top side of said fabric sheet is colored to match the outer surface of the article of clothing.

4. The patch as recited in claim 1 wherein said fabric sheet is digitally printed with a color pattern appearing on the top side of said fabric sheet for matching a color pattern on the article of clothing.

5. The patch as recited in claim 1 wherein said fabric sheet is digitally printed with a camouflage pattern appearing on the top side of said fabric sheet for matching a camouflage pattern on the article of clothing.

6. A patch for repairing a tear or hole in an article of clothing, comprising:
a sheet of fabric having a top side and a bottom side;
a pressure sensitive adhesive composition bonded to the bottom side of said fabric sheet by heat melt lamination; and
a removable backing sheet for protectively covering said pressure sensitive adhesive prior to application of said patch to the article of clothing.

7. The patch as recited in claim 6 wherein the top side of said fabric sheet is colored to match the outer surface of the article of clothing.

8. The patch as recited in claim 6 wherein said fabric sheet is digitally printed with a color pattern appearing on the top side of said fabric sheet for matching a color pattern on the article of clothing.

9. The patch as recited in claim 6 wherein said fabric sheet is digitally printed with a camouflage pattern appearing on the top side of said fabric sheet for matching a camouflage pattern on the article of clothing.

10. A method of applying the patch of claim 6 to the article of clothing comprising the steps of:
lying an area of the article of clothing to be repaired on a flat, rigid surface and the area to be repaired defining an area of patch application;
removing wrinkles and bumps from the area of patch application;
pulling the edges surrounding the tear or hole in the article of clothing, within the area of patch application, together to reduce the size of the tear or hole opening;
applying the bottom side of said fabric sheet of said patch having said pressure sensitive adhesive composition onto the area of patch application surrounding the tear or hole;
pressing against the top side of said fabric sheet of said patch to remove wrinkles, creases and air pockets between said patch and the article of clothing;
rubbing the top side of said fabric sheet of said patch with a smooth surface of a rigid article to remove air pockets, wrinkles and creases; and
generating heat while rubbing to accelerate the adhesion of said pressure sensitive adhesive composition to the article of clothing.
